(19) United States
(12) Patent Application Publication
(10) Pub. No.: US 2020/0111035 A1
(43) Pub. Date: Apr. 9, 2020

(54) INFORMATION PROCESSING METHOD AND INFORMATION PROCESSING APPARATUS

(71) Applicant: FUJITSU LIMITED, Kawasaki-shi (JP)

(72) Inventors: Katsuhito Nakazawa, Urawa (JP); Tetsuyoshi Shiota, Yokohama (JP); Takahiro HOSHINO, Minato (JP); Yuki SAITO, Minato (JP); Takayuki TODA, Minato (JP); Yuya MATSUMURA, Minato (JP)

(73) Assignee: FUJITSU LIMITED, Kawasaki-shi (JP)

(21) Appl. No.: 16/704,285

(22) Filed: Dec. 5, 2019

Related U.S. Application Data
(63) Continuation of application No. PCT/JP2017/021386, filed on Jun. 8, 2017.

(51) Int. Cl. G06Q 10/06; G06Q 10/04; G06Q 50/26

(52) U.S. Cl. CPC G06Q 10/067; G06Q 10/0631; G06Q 50/26; G06Q 10/04

(57) ABSTRACT

An information processing method includes calculating, for each reference target among reference targets to which a measure has been applied, a difference between a value of an index of the reference target linked to predetermined variables, and a value of the index of the reference target obtained under a virtual scenario in which the measure is not applied to the reference target, as a first index value difference, calculating a relation expression that links the first index value difference to the predetermined variables, and calculating, by using the predetermined variables of a target and the relation expression, a difference between a value of the index of the target obtained under a virtual scenario in which the measure is applied to the target and a value of the index of the target obtained when the measure is not applied to the target, as a second index value difference.

### CROSS-REFERENCE TO RELATED APPLICATIONS

This application is a continuation application of International application PCT/JP2017/021386 filed on Jun. 8, 2017 and designated the U.S., the entire contents of which are incorporated herein by reference.

### FIELD

The disclosures herein relate to an information processing method, an information processing apparatus, and a non-transitory computer-readable storage medium for storing program, to calculate a variation in a value of an index when a measure is applied to a target.

### BACKGROUND

A local government may need to consider introducing a new measure in order to revitalize their communities (e.g., Patent Document 1 and Patent Document 2). Introducing a new measure requires a substantial amount of budget and time, and it is preferable to consider an effect on a local government caused by an introduction of a new measure in advance of the introduction.

In respect to a value of an index reflecting an influence of a measure, a local government attempts to compare a value of the index when a new measure is introduced and a value of the index when a new measure is not introduced in order to estimate an effect of new measure introduction.

Technology using counterfactual thinking is proposed as a method to estimate an effect caused by a new measure introduction in local government, for example.

FIG. 1 is a drawing illustrating a counterfactual thinking method of related art.

In the technology using counterfactual thinking, City A that has introduced a new measure is selected, and a plurality of local governments that are similar to City A in a population, an industrial structure, or the like, and do not introduce the measure, are selected. A virtual model of City A is created as a model of City A before the measure is introduced based on values of an index of the similar local governments that have introduced the measure and explanatory variables whose objective variables are a value of the index. A value of the index is a value that reflects an influence of the measure and can be an index of an effect of the measure. A value of the index is the number of manufacturing workers, for example. The virtual model of City A is created by a publicly known technology such as a propensity score method, a matching method, or a difference in differences method, for example. A curve 100 indicating a value of the index of City A before the measure is introduced is obtained by using the virtual model of City A.

A difference between a curve 101 indicating an actual value of the index after the measure is introduced in City A and the curve 100 indicating a value of the index of the virtual model of City A when the measure is not introduced, is quantitatively obtained as an effect caused by introducing the measure in City A at time t0.

According to the counterfactual thinking described above, for a local government in which a measure has been already introduced, a value of an index when a measure is not introduced in the local government can be estimated.

It is expected to obtain a future value of an index by using a virtual scenario in which a measure is introduced in a local government where a measure is not introduced, and calculate an effect caused by introducing a measure in the local government.

However, a technology to meet the expectation is not proposed yet.

### RELATED-ART DOCUMENTS

### Patent Document

[Patent Document 1] Japanese Laid-Open Patent Publication No. 2007-41705

[Patent Document 2] Japanese Laid-Open Patent Publication No. 2015-132863

### SUMMARY

According to an aspect of the embodiment, an information processing method includes calculating, for each reference target among a plurality of reference targets to which a measure has been applied, a difference between a value of an index of a reference target being said each reference target linked to predetermined variables that change over time and that are influenced by the measure, and a value of the index of the reference target obtained under a virtual scenario in which the measure is not applied to the reference target, as a first index value difference occurring when the measure is applied to the reference target, calculating a relation expression that links the first index value difference to the predetermined variables based on the first index value difference and the predetermined variables of each reference target among the reference targets, and calculating, by using the predetermined variables of a target and the relation expression, a difference between a value of the index of the target obtained under a virtual scenario in which the measure is applied to the target and a value of the index of the target obtained when the measure is not applied to the target, as a second index value difference.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating a counterfactual thinking method of related art;

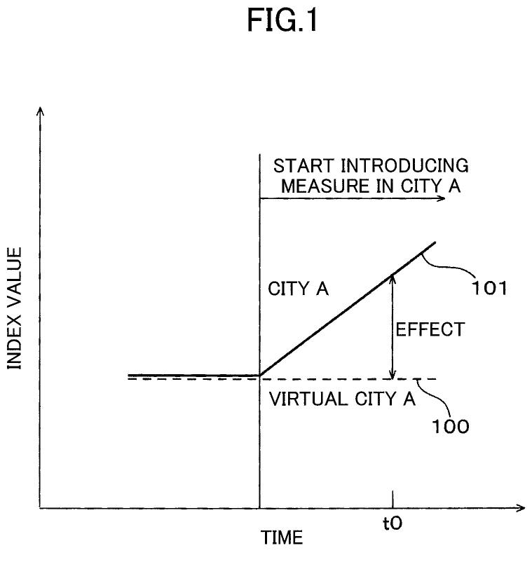

FIG. 2 is a drawing illustrating an example of an embodiment of an information processing apparatus disclosed herein;

FIG. 3A is a drawing illustrating a processor and FIG. 3B is a drawing illustrating a memory;

FIG. 4 is a drawing illustrating an effect obtained by an information processing apparatus disclosed herein under a virtual scenario in which a measure is introduced in a local government;

FIG. 5 is a drawing illustrating a flow chart describing operations of an information processing apparatus disclosed herein;

FIG. 6 is a drawing illustrating a table indicating transition of the actual number of manufacturing workers in respective second similar local governments where a measure is introduced;

FIG. 7 is a drawing illustrating transition of estimated numbers of manufacturing workers in respective second similar local governments under a virtual scenario in which a measure is not introduced;

FIG. 8 is a drawing illustrating a table indicating variations in the numbers of manufacturing workers in respective second similar local governments caused by introducing a measure;

FIG. 9 is a drawing illustrating a table of parameters of a linear model indicating a relationship between a variation in the number of manufacturing workers and an explanatory variable; and

FIG. 10 is a drawing illustrating variations in the numbers of manufacturing workers in City A under a virtual scenario in which a measure is introduced in City A.

### DESCRIPTION OF EMBODIMENTS

In the following, a preferred embodiment of an information processing apparatus disclosed here will be described with reference to the accompanying drawings. However, the technical scope of the present invention is not limited to these embodiments, and is intended to cover the invention described in the claims and equivalents.

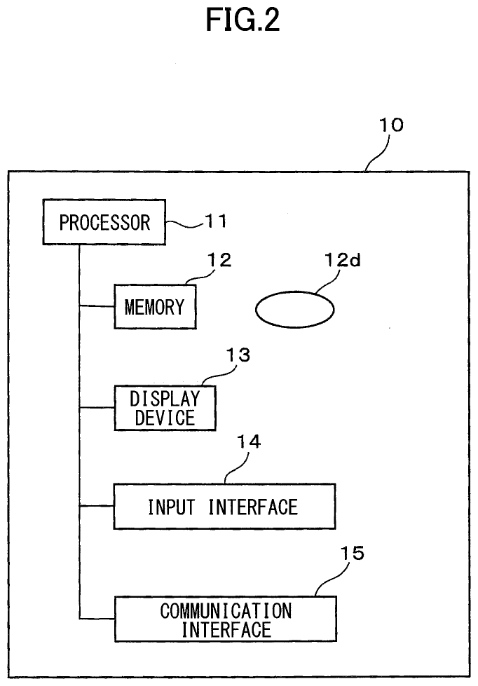

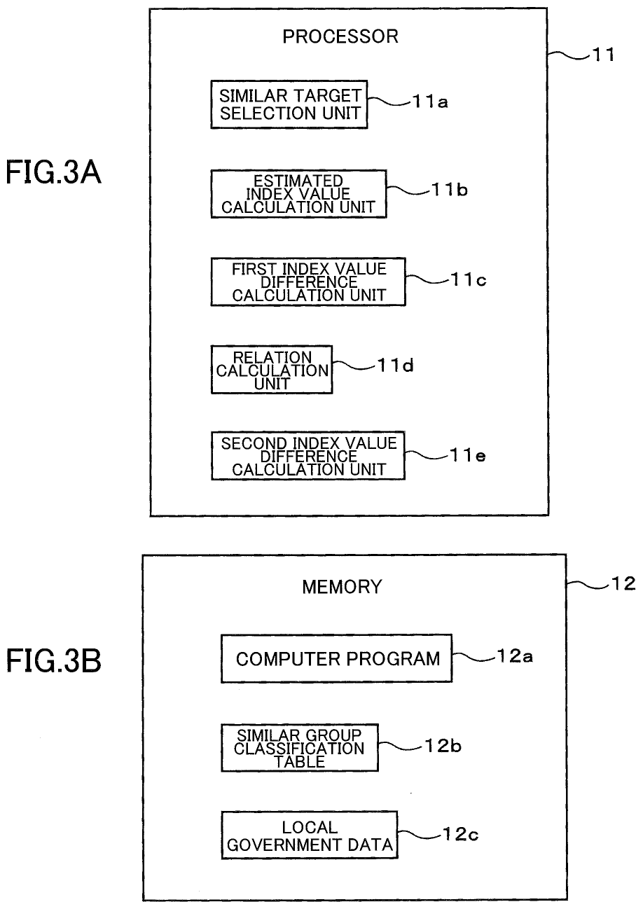

FIG. 2 is a drawing illustrating an example of an embodiment of an information processing apparatus disclosed herein. FIG. 3A is a drawing illustrating a processor and FIG. 3B is a drawing illustrating a memory.

The information processing apparatus (which will hereinafter be referred to as the apparatus) 10 of this embodiment obtains a value of an index by using a virtual scenario in which a measure is applied to a target such as a local government to which the measure is not applied, and calculates an effect of applying the measure to the target. As described above, a value of the index reflects an influence of the measure, and is a value that can be an index of the effect of the measure.

A measure applied to a local government may include a measure to construct an industrial park in a local government in order to invite companies to a local government.

A target to which a measure is applied is not limited to a local government. For example, the target may include a patient treated in a medical institution and a company.

In the following of this specification, the apparatus 10 will be described by an example of a local government as a target to which a measure is applied.

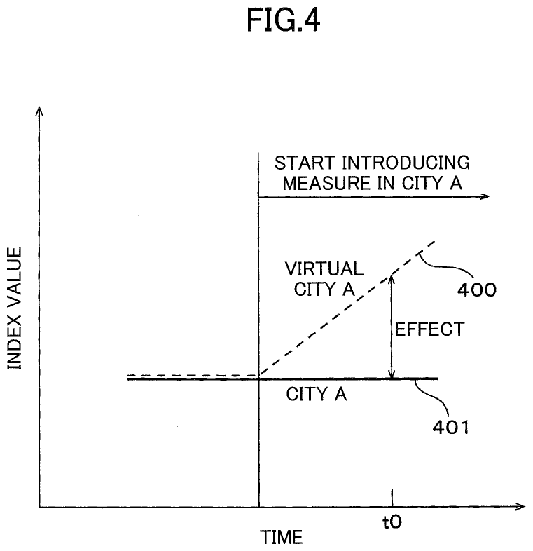

FIG. 4 is a drawing illustrating an effect obtained by the information processing apparatus disclosed herein under a virtual scenario in which a measure is introduced in a local government. In this specification, introducing a measure in a local government (i.e. a target) has the same meaning as applying a measure to a local government (i.e., a target).

With respect to a local government City A that is input by a user as a target, the apparatus 10 calculates a value of an index of virtual City A under a virtual scenario in which a measure is introduced. The apparatus 10 calculates a difference between a curve 400 indicating a value of an index of virtual City A under a virtual scenario in which a measure is introduced and a curve 401 indicating a value of an index of City A where the measure is not introduced, as an effect at time t0 of applying the measure to City A.

As illustrated in FIG. 2, the apparatus 10 includes a processor 11, a memory 12, a display device 13, an input interface 14, and a communication interface 15. The processor 11 is an example of a processing unit or a processing apparatus. The memory 12 is an example of a storage unit or a storage apparatus.

Details of hardware components of the apparatus 10 will be described in the following.

The processor 11 includes one or more central arithmetic circuits and peripheral circuits such as a register, a cache memory, and an interface. The processor 11 controls hardware components of the apparatus 10 and performs various processes based on a predetermined program 12a stored in the memory 12 in advance, and uses the memory 12 to store data generated by processing temporarily.

The memory 12 may include a semiconductor memory such as a random access memory (RAM) and a read only memory (ROM), or a non-volatile memory such as a magnetic disk and a flash memory. The memory 12 may include a program stored in a non-temporary recording medium 12d, in a readable drive (which is not illustrated).

As illustrated in FIG. 3B, the memory 12 stores a similar group classification table 12b in which the degree of the similarity among local governments is classified and registered based on information such as a population and an industrial structure in each local government, in addition to the predetermined program 12a. The memory 12 stores local government data 12c in which a population, the number of welfare facilities for the elderly, product shipment value, the number of deaths, the number of elementary school students, and the like are registered for each local government per year. The similar group classification table 12b may be stored in an external server, which is not illustrated, and the apparatus 10 may refer to the similar group classification table 12b by communicating with the server through a network, which is not illustrated.

The display device 13 is controlled by the processor 11 and various information associated with operations of the apparatus 10 can be displayed on a screen. A liquid crystal display can be used as the display device 13, for example.

The input interface 14 is operated by a user of the apparatus 10 and operations can be input. The input interface 14 can use a keyboard or mouse as the input interface 14.

The communication interface 15 sends and receives information through a network, which is not illustrated, for example. The communication interface 15 includes a communication circuit and a communication line for sending and receiving. The apparatus 10 may send and receive a program or information included in the similar group classification table 12b, or the local government data 12c by using the communication interface 15.

As illustrated in FIG. 3A, the processor 11, which is described above, includes a similar target selection unit 11a, an estimated index value calculation unit 11b, a first index value difference calculation unit 11c, a relation calculation unit 11d, and a second index value difference calculation unit 11e.

These units included in the processor 11 are functional modules implemented by a computer program that is performed on the processor 11, for example. The units included in the processor 11 may be equipped in the apparatus 10 as separate circuits. The operation of each unit will be described later.

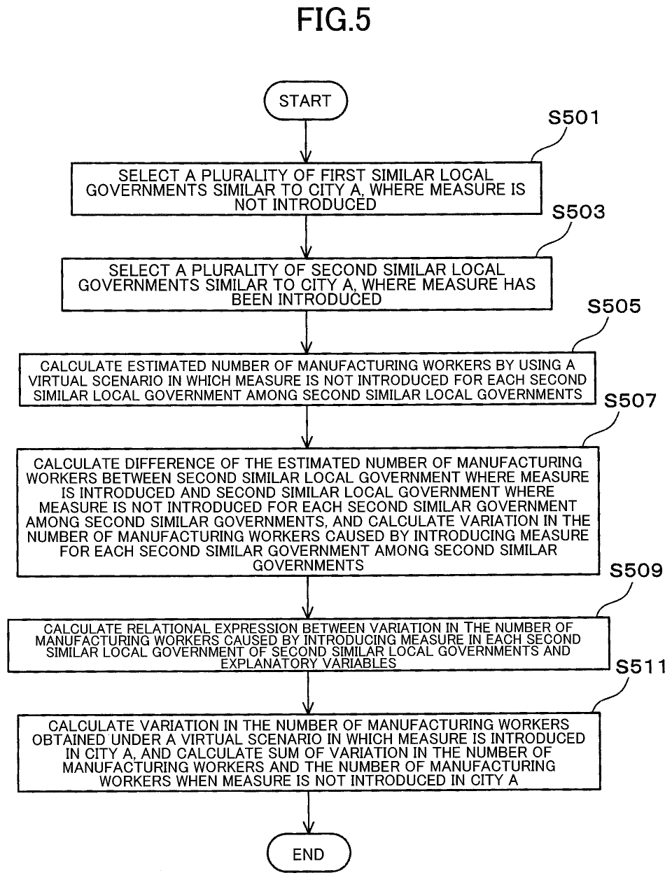

The operation of the apparatus 10 described above, will be described in the following with reference to a flowchart illustrated in FIG. 5. In this embodiment, the apparatus 10 calculates a variation (i.e., an index value difference) of the number of industrial workers (i.e., a value of an index) as an effect of introducing a measure when a measure to construct an industrial park is introduced in a local government City A given by a user (i.e., a target).

In step S501, the similar target selection unit 11a of the processor 11 selects a plurality of first similar local governments that are local governments similar to City A, in which the measure is not introduced. For each first similar local government, a direction in which the number of the industrial workers increases or decreases, when explanatory variables whose target variable is the number of industrial workers in the first similar local government change, is the same as a direction in which the number of the industrial workers increases or decreases, when explanatory variables of the number of industrial workers in City A change. The explanatory variables are affected and changed over time by applying the measure to the first similar local governments. A value of the index of the number of the manufacturing workers or the like is related to the explanatory variables and a value of the index may have a predetermined relationship with the explanatory variable.

Based on similar group classification which is government statistical data, local governments similar to City A are selected from local governments that are classified into the same classification name. The similar target selection unit 11a selects local governments in which the measure to construct an industrial park is not introduced, from the local governments classified into the same classification name as City A, by referring to the similar group classification table 12b and a table in which the relationship between each local government and the introduction of the measure is recorded, stored in the memory 12. The similar target selection unit 11a selects all of the selected local governments or a predetermined number of the selected local governments as the plurality of the first similar local governments. When the similar target selection unit 11a selects a predetermined number of local governments, for example, the similar target selection unit 11a may select local governments whose population is within a predetermined range based on the population of City A. Alternatively, when the similar target selection unit 11a selects a predetermined number of local governments, the similar target selection unit 11a may select local governments whose percentages of a primary industry, a secondary industry, and a tertiary industry are within a predetermined range based on the percentages of City A.

The number of the first similar local governments in which the measure is not introduced may be appropriately determined in accordance with accuracy required for the number of estimated manufacturing workers calculated in the next step. It is considered that the more similar in a population and an industrial structure the local governments are selected based on the similar group classification, the more accurate the estimated number of industrial workers is. In contrast, the more similar in a population and an industrial structure the local governments are selected, the less local governments are selected, and accuracy of the estimated number of industrial workers calculated by regression analysis or the like tends to be decreased.

In step S503, the similar target selection unit 11a selects a plurality of second similar local governments (which are corresponding to a plurality of reference targets in claim 1) that are local governments similar to City A, in which the measure has been introduced. For each second similar local government, a direction in which the number of the industrial workers increases or decreases, when the explanatory variables whose target variable is the number of industrial workers in the second similar local government change, is the same as a direction in which the number of the industrial workers increases or decreases, when the explanatory variables of the number of industrial workers in City A change. The explanatory variables are affected and changed over time by applying the measure to the second similar local governments. The explanatory variables of the number of industrial workers in the second similar local governments are usually the same as the explanatory variables of the number of industrial workers in the first similar local governments.

The similar target selection unit 11a selects local governments in which the measure to construct an industrial park has been introduced, from a plurality of local governments classified into the same classification name as City A, by referring to the similar group classification table 12b and a table in which the relationship between each local government and the introduction of the measure is recorded, stored in the memory 12. The similar target selection unit 11a selects all of the selected local governments or a predetermined number of the selected local governments as the plurality of the second similar local governments (e.g., City B to City F). When the similar target selection unit 11a selects a predetermined number of local governments, for example, the similar target selection unit 11a may select local governments whose population is within a predetermined range based on the population of City A. Alternatively, when the similar target selection unit 11a selects a predetermined number of local governments, the similar target selection unit 11a may select local governments whose percentages of a primary industry, a secondary industry, and a tertiary industry are within a predetermined range based on the percentages of City A.

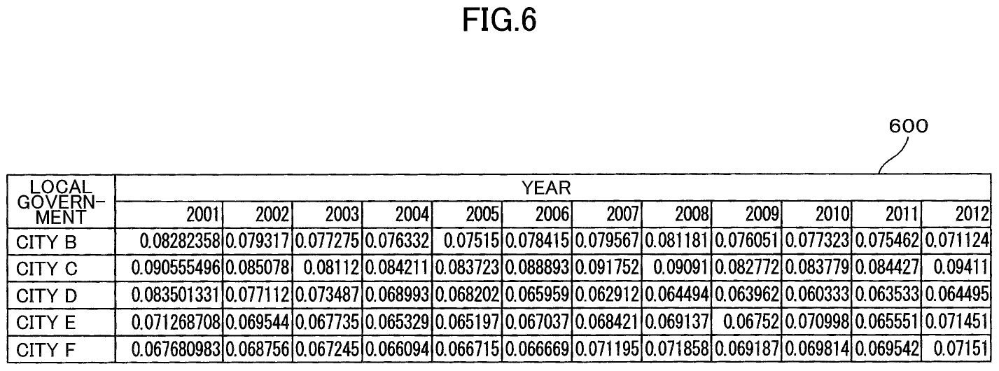

FIG. 6 is a drawing illustrating a table 600 indicating transition of the actual number of manufacturing workers in the respective second similar local governments (e.g., City B to City F) where the measure is introduced.

The table 600 indicates a relationship between the actual number of manufacturing workers in a city of the cities from City B to City F that are the second similar local governments in which the measure is introduced and the year, for each city and each year. The relationship between the actual number of manufacturing workers in a city of the cities from City B to City F and the year for each city and each year indicated in the table 600 is registered in the local government data 12c stored in the memory 12. The table 600 indicates the ratio of the number of manufacturing workers per one million inhabitants. For example, the value of 0.08282358 for City B in 2001 indicates 82823.58 people. For City B to City F, the measure was introduced in 2009. The table 600 indicates the relationship between the actual number of manufacturing workers and the year from 2001 to 2012, which ranges from before the measure introduction to after the measure introduction.

The number of the second similar local governments may be appropriately determined in accordance with accuracy required for the number of estimated manufacturing workers calculated in the next step. It is considered that the more similar in a population and an industrial structure the local governments are selected based on the similar group classification, the more accurate the estimated number of industrial workers is. In contrast, the more similar in a population and an industrial structure the local governments are selected, the less local governments are selected, and accuracy of the estimated number of industrial workers calculated by regression analysis or the like tends to be decreased.

In step S505, the estimated index value calculation unit 11b of the processor 11 calculates, for each second similar local government, an estimated number of manufacturing workers that is the number of manufacturing workers estimated under a virtual scenario in which the measure is not applied to the second similar local government. Specifically, for each second similar local government (e.g., City B to City F), the estimated index value calculation unit 11b obtains explanatory variables whose objective variable is the number of manufacturing workers in the second similar local government. The estimated index value calculation unit 11b calculates, for each second similar local government, the estimated number of manufacturing workers in the second similar local government based on a relationship between the estimated number of manufacturing workers and the explanatory variables of the second similar local government, and the explanatory variables of the second similar local government.

A process in which the estimated index value calculation unit 11b selects the explanatory variables whose objective variable is the number of manufacturing workers will be described. Subsequently, a process in which the estimated index value calculation unit 11b calculates the estimated number of manufacturing workers in the second similar local governments will be described.

The estimated index value calculation unit 11b reads first time-series data indicating the number of manufacturing workers in a plurality of local governments including City A per year, from the local government data 12c stored in the memory 12. The estimated index value calculation unit 11b reads second time-series data indicating a plurality of indexes that have a causal relationship with the number of manufacturing workers in the local governments including City A per year from the local government data 12c stored in the memory 12, except the number of manufacturing workers. The indexes that have a causal relationship with the number of manufacturing workers except the number of manufacturing workers may be changed when the number of manufacturing workers is changed. The indexes include a population and the number of welfare facilities for the elderly, for example.

The first time-series data has a data structure in which column data including the numbers of manufacturing workers in the local governments including City A are arranged in the order of the year.

The second time-series data has a data structure in which column data including the indexes that have a causal relationship with the number of manufacturing workers in the local governments including City A except the number of manufacturing workers (e.g., a population and the number of welfare facilities for the elderly) are arranged in the order of the year. The first time-series data and the second time-series data may not include information of City A.

For each index of the second time-series data indicating the indexes per year except the number of manufacturing workers, the estimated index value calculation unit 11b calculates correlation coefficients between column data of the second time-series data and column data of the first time-series data at reference time. The reference time is one of the year included in the first time-series data and may be selected as suited. As a result, for each index of the second time-series data indicating the indexes per year except the number of manufacturing workers, the estimated index value calculation unit 11b calculates correlation coefficients to column data of the first time-series data at the reference time among the first time-series data indicating the indexes per year.

The method to obtain a correlation coefficient is not limited. The estimated index value calculation unit 11b calculates a correlation coefficient by using expression (1) below.

$$R = \frac{{\sum }_{i = 1}^{n} ( {x}_{i} - {x}_{a} ) ( {y}_{i} - {y}_{a} )}{\sqrt{{\sum }_{i = 1}^{n} {( {x}_{i} - {x}_{a} )}^{2}} \sqrt{{\sum }_{i = 1}^{n} {( {y}_{i} - {y}_{a} )}^{2}}} \qquad ( 1 )$$

Here, the variable n indicates the number of data included in each column data and is corresponding to the number of the local governments. The variable xᵢ indicates a value of i-th data of the column data at reference time in the first time-series data. The variable yᵢ indicates a value of i-th data of the column data at a given year in the second time-series data. The variable xₐ is an average value of the column data at reference time in the first time-series data. The variable yₐ is an average value of the column data at the given year in the second time-series data.

In correlation coefficients per year calculated for each index of the plurality of the indexes except the number of manufacturing workers, the estimated index value calculation unit 11b selects correlation coefficients that are more than correlation coefficients calculated for a reference year, as processing targets.

The estimated index value calculation unit 11b arranges correlation coefficients selected as the processing targets in the time-series order, and creates an approximate straight line.

For each of the indexes except the number of manufacturing workers, the estimated index value calculation unit 11b determines an index that has a strong causal relationship with the number of manufacturing workers when a slope of an approximate straight line of the index is positive by checking whether a slope of an approximate straight line of the index is positive or negative.

The estimated index value calculation unit 11b selects all the indexes that generate an approximate straight line whose slope is positive, or indexes that generate an approximate straight line whose slope is positive and more than a predetermined threshold, as the explanatory variables to the number of manufacturing workers, from the indexes except the number of manufacturing workers. A predetermined threshold may be an average value of positive values of the slopes of the indexes, for example.

Based on the process described above, the estimated index value calculation unit 11b selects the number of welfare facilities for the elderly, product shipment value, the number of deaths, and the number of elementary school students as the explanatory variables whose objective variable is the number of manufacturing workers.

The reason why the correlation between the number of manufacturing workers and each one of the number of welfare facilities for the elderly, the number of deaths, and the number of elementary school students is high is considered that when the number of manufacturing workers is increased, the number of family members of manufacturing workers is also increased, and the numbers of elderly persons and elementary school students are increased. As the members of family of manufacturing workers are increased, it is considered that the number of members of family of manufacturing workers who die is increased.

When the number of manufacturing workers is increased, the number of products manufactured by manufacturing workers is increased. Consequently, it is considered that product shipment value is also increased.

Variables that have a causal relationship with a value of an index can be used as explanatory variables, and the high degree of causal relationship with a value of an index is preferred. Thus, in this embodiment, explanatory variables are selected based on the idea described above.

For each of the second similar local governments (e.g., City B to City F), the estimated index value calculation unit 11b calculates the estimated number of manufacturing workers in the second similar local government based on a relationship between the estimated number of manufacturing workers and the explanatory variables of the second similar local government, and the explanatory variables of the second similar local government. The relationship between the estimated number of manufacturing workers and the explanatory variables of the second similar local governments is obtained based on the relationship between the number of manufacturing workers obtained based on the explanatory variables of the first similar local governments and the explanatory variables of the first similar local governments by using a propensity score method, a matching method or a difference in differences method, for example. The estimated index value calculation unit 11b may obtain a relationship between the number of manufacturing workers and the explanatory variables of the second similar local governments based on a relationship between the number of manufacturing workers obtained based on the explanatory variables of the first similar local governments and the explanatory variables of the first similar local governments by using publicly known counterfactual thinking.

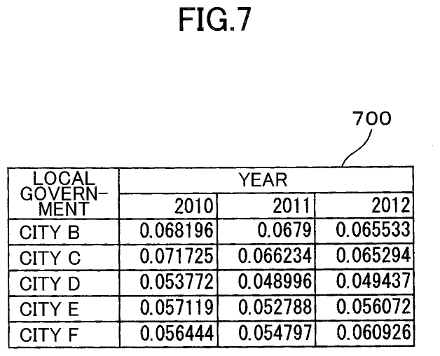

FIG. 7 is a drawing illustrating a table 700 indicating transition of an estimated number of manufacturing workers in respective second similar local governments under a virtual scenario in which the measure is not introduced.

The table 700 indicates a relationship between the number of manufacturing workers in City B to City F, which are the second similar local governments observed under a virtual scenario in which the measure is not introduced, and the year. As the measure is introduced in City B to City F in 2009, the table 700 indicates the number of manufacturing workers from the year of 2010, which is the next year from when the measure was introduced.

In step S507, for each of the second similar local governments (e.g., City B to City F), the first index value difference calculation unit 11c of the processor 11 calculates a difference of the number of manufacturing workers and the estimated number of manufacturing workers in the second similar local government as a difference of the number of manufacturing workers when the measure is introduced in the second similar local government.

Thus, the first index value difference calculation unit 11c calculates differences between the actual number of manufacturing workers in City B to City F from the year 2010 to 2012 (FIG. 6) and the estimated number of manufacturing workers in City B to City F (FIG. 7), respectively.

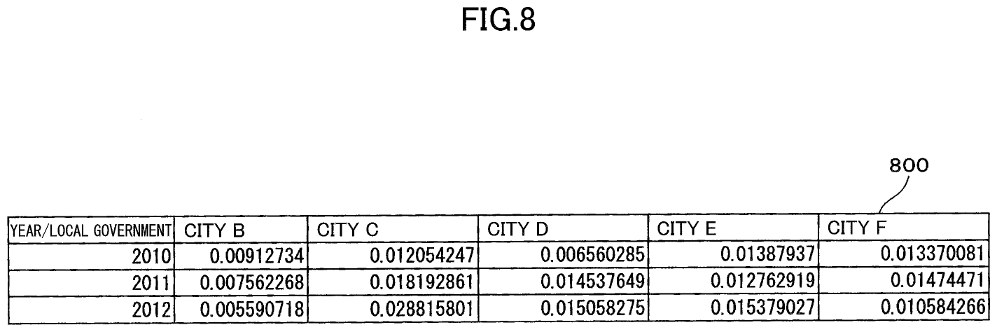

FIG. 8 is a drawing illustrating a table 800 indicating variations in the numbers of manufacturing workers in respective second similar local governments caused by introducing the measure.

Variations in the numbers of manufacturing workers in the respective second similar local governments (City B to City F) indicate effects on the corresponding one of the second similar local governments caused by introducing the measure. As illustrated in the table 800, the number of manufacturing workers in the year in each of the cities from City B to City F for each year indicates a positive value, and the number of manufacturing workers is increased by introducing the measure.

In step S509, the relation calculation unit 11d of the processor 11 calculates a relation expression that links variations in the numbers of manufacturing workers and the explanatory variables based on variations in the number of manufacturing workers and the explanatory variables of the respective second similar local governments (City B to City F). The relation calculation unit 11d uses the number of welfare facilities for the elderly, the product shipment value, the number of deaths, and the number of elementary school students determined in step S505 as the explanatory variables.

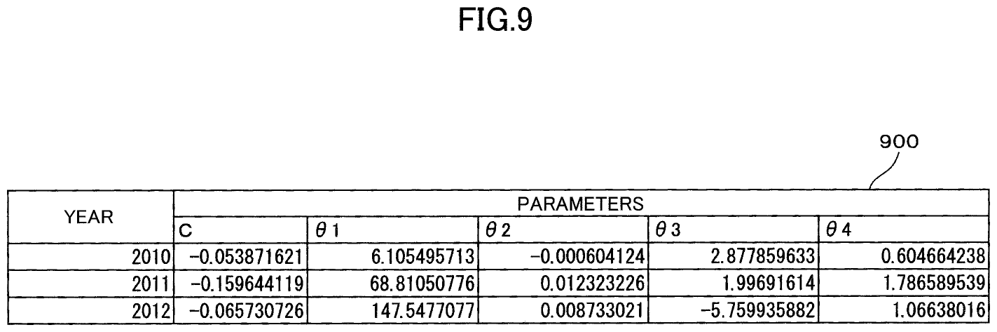

The relation calculation unit 11d reads time-series data of the number of welfare facilities for the elderly, the product shipment value, the number of deaths, and the number of elementary school students in each of the cities from City B to City F for each year from the local government data 12c stored in the memory 12. The relation calculation unit 11d conducts a regression analysis based on the time-series data of the variations in the number of manufacturing workers in each of City B to City F for each year illustrated in FIG. 8, and the time-series data of the explanatory variables of each city of City B to City F read from the memory 12. In this specification, the relation calculation unit 11d conducts the regression analysis of a linear model indicated by the following expression (2), and obtains the parameters illustrated in FIG. 9.

αt=θ1tXt+θ2tYt+θ3tZt+θ4tWt+Ct (2)

Here, αt is a variation in the number of manufacturing workers at the year of t, Xt is the number of welfare facilities for the elderly at the year of t, Yt is product shipment value at the year of t, Zt is the number of deaths at the year of t, and Wt is the number of elementary school students at the year of t. θ1t is a coefficient of Xt, θ2t is a coefficient of Yt, θ3t is a coefficient of Zt and θ4t is a coefficient of Wt. Ct is a coefficient for each year. FIG. 9 is a drawing illustrating a table 900 that indicates concrete values of the parameters θ1t, θ2t, θ3t, θ4t, and Ct.

In step S511, the second index value difference calculation unit 11e of the processor 11 calculates the variations in the number of manufacturing workers under a virtual scenario in which the measure is applied to City A by using the explanatory variables of City A and the relationship of the expression (2) described above. The second index value difference calculation unit 11e calculates a sum of the variation in the number of manufacturing workers and the number of manufacturing workers in City A when the measure is not applied as the number of manufacturing workers obtained under a virtual scenario in which the measure is applied to City A.

When the second index value difference calculation unit 11e calculates the variations in the numbers of manufacturing workers in City A in the past, the second index value difference calculation unit 11e reads the explanatory variables of City A in the past for each year from the local government data 12c stored in the memory 12, and applies the explanatory variables to the expression (2) above.

When the second index value difference calculation unit 11e calculates variations in the number of manufacturing workers over time in the future, the second index value difference calculation unit 11e estimates the explanatory variables of City A in the future when the measure is not introduced. The second index value difference calculation unit 11e calculates the explanatory variables of City A from the past to the present when the measure is not introduced by using an existing method of counterfactual thinking, and can estimate the future explanatory variables of City A based on the explanatory variables of City A from the past to the present. The second index value difference calculation unit 11e calculates future variations in the number of manufacturing workers obtained under a virtual scenario in which the measure is applied to City A, by using the future explanatory variables of City A and the relationship of the expression (2) above.

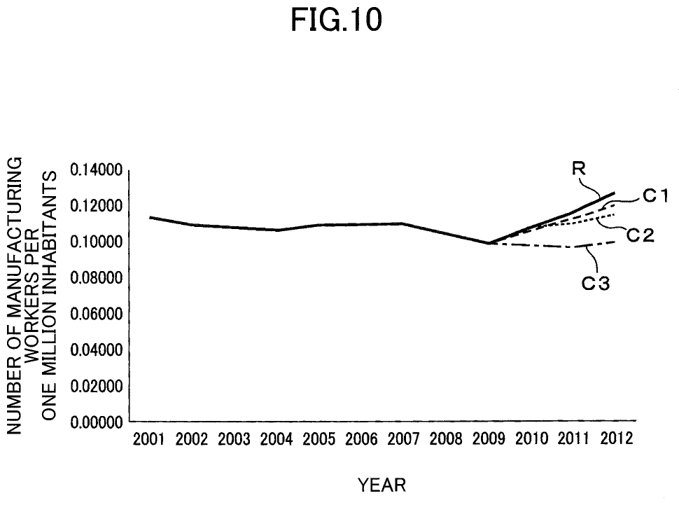

FIG. 10 is a drawing illustrating the number of manufacturing workers in City A under a virtual scenario in which a measure is introduced in City A.

A curve C1 indicates the number of manufacturing workers in City A obtained under a virtual scenario in which the measure has been introduced in City A from 2001 to 2012. A curve R indicating the actual number of manufacturing workers in City A from 2001 to 2012 in the past, is illustrated in comparison with the curve C1 generated by the apparatus 10.

Actually, the measure to construct an industrial park has been introduced in City A since 2009, and the curve R is generated based on the actual number of manufacturing workers in City A. The measure has been actually introduced in City A since 2009, however the curve C1 is generated by using a virtual scenario in which the measure is introduced in City A, and the curve C1 indicates the number of manufacturing workers in City A obtained under a virtual scenario in which the measure is applied to City A.

In FIG. 10, the curve C2 is created based on an average value of the variations in the numbers of manufacturing workers by introducing the measure in City B to City F. By using an existing method of counterfactual thinking, the curve C3 is created by obtaining the number of manufacturing workers in virtual City A under a virtual scenario in which the measure is not introduced in City A.

The curve C1 indicates values closer to the curve R than the curve C2, and calculates changes over time in the number of manufacturing workers of City A more accurately.

FIG. 10 indicates changes over time in the number of manufacturing workers of City A in the past, and the apparatus 10 can also calculate the number of manufacturing workers in City A in the future. The apparatus 10 calculates the number of manufacturing workers in City A in the future by substituting the future explanatory variables of City A when the measure is not introduced in City A into the expression (2) above. The future explanatory variables may be calculated by the apparatus 10, or may be given by a user.

According to the apparatus of this embodiment described above, effectiveness of the measure applied to a target to which the measure is not applied can be determined by obtaining a difference between a value of an index obtained under a virtual scenario in which the measure is introduced and a value of an index when a measure is not introduced in the target. Specifically, an effect of introducing a measure can be estimated by using future explanatory variables of a target.

In the present embodiment, the information processing method, the information processing apparatus, and the information processing computer program of this embodiment described above may be modified if necessary without departing from the spirit and scope of the invention.

For example, although the target is a local government in the embodiment described above, the target is not limited to a local government. For example, a patient treated in a medical institution or a company may be used as a target.

When a patient is used as a target, an index of a patient may include a value indicating a health condition of a patient such as a blood glucose value. Similar patients who are similar to a target patient may include patients who are the same age as a target patient or close in age to a target patient, or patients who are the same gender as a target patient.

When a company is used as a target, an index of a company may include values of sales, ordinary profit, and the like. Similar companies that are similar to a target company may include companies that are the same as or similar to a target company in the number of employees, the amount of capital, or the type of industry.

In the embodiment described above, the apparatus 10 selects a plurality of the first similar local governments and the second local governments. Alternatively, the apparatus 10 may perform processes in step S505 and onward illustrated in FIG. 5 based on a plurality of the first similar local governments or the second local governments or both selected by a user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An information processing method, comprising:
calculating, for each reference target among a plurality of reference targets to which a measure has been applied, a difference between a value of an index of a reference target being said each reference target linked to predetermined variables that change over time and that are influenced by the measure, and a value of the index of the reference target obtained under a virtual scenario in which the measure is not applied to the reference target, as a first index value difference occurring when the measure is applied to the reference target;
calculating a relation expression that links the first index value difference to the predetermined variables based on the first index value difference and the predetermined variables of each reference target among the reference targets; and
calculating, by using the predetermined variables of a target and the relation expression, a difference between a value of the index of the target obtained under a virtual scenario in which the measure is applied to the target and a value of the index of the target obtained when the measure is not applied to the target, as a second index value difference.

2. The information processing method as claimed in claim 1, wherein, for each reference target among the reference targets, a direction in which a value of the index of the reference target increases or decreases when the predetermined variables of the reference target change is the same as a direction in which a value of the index of the target increases or decreases when the predetermined variables of the target change.

3. The information processing method as claimed in claim 1, wherein calculating the relation expression includes calculating the relation expression by conducting a regression analysis with respect to the first index value difference and the predetermined variables of each reference target among the reference targets.

4. The information processing method as claimed in claims 1, further comprising calculating a sum of the first index value difference and a value of the index of the target when the measure is not applied to the target.

5. The information processing method as claimed in claims 1, wherein the target is a local government, and the target and the reference targets are similar in a population or an industrial structure.

6. The information processing method as claimed in claims 1, wherein the target is a patient being treated, and the target and the reference targets are the same gender or of similar age.

7. The information processing method as claimed in claims 1, wherein the target is a company, and the target and the reference targets are similar in the number of employees, an amount of capital or a type of industry.

8. An information processing apparatus comprising a processing unit including:
a first index value difference calculation unit configured to calculate, for each reference target among a plurality of reference targets to which a measure has been applied, a difference between a value of an index of a reference target being said each reference target linked to predetermined variables that change over time and that are influenced by the measure, and a value of the index of the reference target obtained under a virtual scenario in which the measure is not applied to the reference target, as a first index value difference occurring when the measure is applied to the reference target;
a relation calculation unit configured to calculate a relation expression that links the first index value difference to the predetermined variables based on the first index value difference and the predetermined variables of each reference target among the reference targets; and
a second index value difference calculation unit configured to calculate, by using the predetermined variables of a target and the relation expression, a difference between a value of the index of the target obtained under a virtual scenario in which the measure is applied to the target and a value of the index of the target obtained when the measure is not applied to the target, as a second index value difference.

9. A computer-readable recording medium having stored therein a program for causing a processor to execute a method comprising:
calculating, for each reference target among a plurality of reference targets to which a measure has been applied, a difference between a value of an index of a reference target being said each reference target linked to predetermined variables that change over time and that are influenced by the measure, and a value of the index of the reference target obtained under a virtual scenario in which the measure is not applied to the reference target, as a first index value difference occurring when the measure is applied to the reference target;
calculating a relation expression that links the first index value difference to the predetermined variables based on the first index value difference and the predetermined variables of each reference target among the reference targets; and
calculating, by using the predetermined variables of a target and the relation expression, a difference between a value of the index of the target obtained under a virtual scenario in which the measure is applied to the target and a value of the index of the target obtained when the measure is not applied to the target, as a second index value difference.
